(19) United States
(12) Patent Application Publication
(10) Pub. No.: US 2022/0394977 A1
(43) Pub. Date: Dec. 15, 2022

(54) COMBINED PREPARATION AND METHOD FOR COMBATING FUNGUS-GROWING ANTS

(71) Applicant: SOLEO ECO-SOLUTIONS, Paris (FR)

(72) Inventors: Bernard JACQUET, Montlhéry (FR); Juliette POIDATZ, Saint Pierre (FR); François-Foulques DES PORTES, Paris (FR)

(21) Appl. No.: 17/774,103

(22) PCT Filed: Nov. 8, 2020
(86) PCT No.: PCT/FR2020/052033

§ 371 Date: May 3, 2022

(30) Foreign Application Priority Data
Nov. 8, 2019 (FR) FR1912582

(51) Int. Cl. A01N 47/02; A01N 41/06

(52) U.S. Cl. CPC A01N 47/02; A01N 41/06

(57) ABSTRACT

The present invention provides a combined formicide preparation comprising at least one insecticide and at least one laccase inhibitor, said laccase inhibitor being present in the preparation at a content of 0.5% or more by weight of the preparation, and the mass ratio between the at least one laccase inhibitor and the at least one insecticide being 2 or more. The present invention also relates to a method of controlling fungus-growing ants and a method of producing a combined formicide preparation.

### FIELD OF THE INVENTION

The invention relates to the field of pest control. It provides a novel combined preparation against fungus-growing ants as well as a novel control method capable of destroying colonies of fungus-growing ants. The present invention also provides a method of producing such a combined preparation.

### PRIOR ART

Fungus-growing ants or “leafcutter ants” or “cassava ants” belong to the family Formicidae, subfamily Myrmicinae, tribe Attini, including several genera such as Atta or Acromyrmex. Fungus-growing ants are found in tropical and subtropical regions such as Central and South America.

The particularity of the tribe Attini, and more particularly of the genera Atta and Acromyrmex, is that the ants belonging to this tribe cultivate, within the anthill, a saprophytic basidiomycete fungus of the genus Leucoagaricus belonging to the family Agaricaceae, with which they are in symbiosis.

The ants ensure the growth of the fungus while it ensures the supply of nutrients for the colony by degrading complex molecules, not assimilable by the ants (Richard et al., 2005). The fungus, supplied with raw material by the ants, is a source of nutrition for the brood, queen, and workers (Qinlan et al., 1978, Fisher et al., 1994), and the fungus is a source of enzymes ensuring the degradation of plant material. In addition, the ants ensure its protection by secreting antibiotics and the fungus allows, during its growth, to maintain the architecture of the nest (Ronald Zanetti et al., 2014).

Fungus-growing ants are a pest for agricultural and forestry crops. Indeed, they are left without predators when they invade monocultures developed by man (a phenomenon accentuated by deforestation) which leads to a strong unregulated presence. Polyphagous, they collect leaves, flowers, fruits and seeds and ravage most agricultural crops, especially food crops, vegetables and ornamental plants.

Damage caused by fungus-growing ants represents an increase in crop management costs. For example, damage to Eucalyptus plantations has been estimated at more than 14.5%, with defoliation in Pine and Eucalyptus crops decreasing the increase in plant size and diameter (Resi Filho et al., 2001, Cantarelli et al. (2008). In addition, damage to grass crops results in losses to the food chain, with losses of between 512 and 870 thousand head of livestock per year, and to the grass crops themselves, with one colony consuming between 90 and 250 kg/year (Fowler et al., 1990 and Amante, 1967). In sugarcane crops, losses can be as high as 3.2 t/ha corresponding to 5.3% of productivity (Precetti et al., 1988) and in fruit crops, losses can reach 100% (Forti and Boaretto, 1997).

The problems associated with fungus-growing ants have led to the development of treatments used to control their expansion, mainly based on chemical pesticides, which have resulted in pollution and soil deterioration. These compounds are now gradually being withdrawn from the market because they pose a risk to humans and the environment.

For more than 20 years, organochlorine insecticides such as aldrin or dechlorane were widely used in agriculture for the control of fungus-growing ants, until their use was suspended by the US-EPA in 1974. In addition, these conventional insecticidal compounds are generally not readily biodegradable and result in persistent toxic activity in soils and waters and a hazard to human health. Organophosphate, organohalogen and pyrethroid insecticides were also used. However, these chemically synthesized insecticides have a harmful impact on humans and the environment. In addition, they are difficult to use and have low efficacy with low mortality rates (Isenring and Neumeister, 2010).

Most of these insecticides had in common that they targeted the nervous system or the metabolic activity of insects in general and not only that of fungus-growing ants. Thus, these non-specific compounds affect other vulnerable species (e.g. bees). Moreover, their action is generally rather fast and targets the insect as such. However, against social insects such as fungus-growing ants, it is preferable to target the colony as a whole, in particular through a joint action against the ants and their symbiotic fungus. This fast action has the merit of quickly stopping the harvesting activity of leafcutter ants. However, it leads to warning mechanisms in the colony which result in the nest moving or the impacted part of the nest being condemned, as well as the ants learning about the danger.

Finally, it was brought to light that fungus-growing ants, as well as the fungus garden, express a polyphenol oxidase enzyme: laccase. This enzyme allows the degradation of lignin and acts on certain polyphenols. Indeed, laccases oxidize phenolic derivatives allowing the formation of monolignols from lignin. More recently, the work of Prof. Mora has shown that laccase was the most expressed enzyme in the enzymatic profiles made from lysates extracted from the garden and ants. Thus, formicide compositions comprising a laccase inhibitor (WO2017/121881) have been developed. Nevertheless, the action of these compositions which kill the fungus garden and thus the nests in depth is observed over a long period of time and does not make it possible to stop the ants' harvesting activity quickly. Compositions comprising a laccase inhibitor were also coupled with an antibacterial to optimize colony disappearance. However, the use of antibacterial agents is less and less recommended due to the development of certain resistant strains. Boulogne et al. (2012) lists insecticidal and antifungal compounds produced by plants as an alternative to synthetic pesticides in the control of fungus-growing ants. Peppermint oil-based compositions are mentioned in the international application WO01/00034 as pesticide compositions for household use. The international application WO2009/117623 mentions pesticide and antiparasitic compositions based on essential oils.

There is therefore a need for new preparations and methods to effectively control fungus-growing ants while reducing the quantities of synthetic insecticides used, avoiding the learning phenomena developed by the ants and killing the nests in depth by a rapid action on the fungus garden.

### Technical Problem

At present, the problem of infestation by fungus-growing ants is still prevalent.

Thus, there is a need for an innovative, low-cost, environmentally benign means of controlling fungus-growing ants. In this context, the present invention provides a novel combined preparation against fungus-growing ants as well as a novel control method capable of rapidly stopping the ants' harvesting activity, of limiting the phenomena of learning and nest moving by rapidly destroying the colonies of fungus-growing ants, in particular by a rapid action on the garden and the ants, while reducing the quantities of synthetic insecticide necessary until now.

### BRIEF DESCRIPTION OF THE INVENTION

To this end, the invention relates to a combined formicide preparation comprising, formulated separately or in a single composition, at least one insecticide and at least one laccase inhibitor, said laccase inhibitor being present in the preparation at a content of 0.5% or more by weight of the preparation, and the mass ratio between the at least one laccase inhibitor and the at least one insecticide being 2 or more.

Such a combined preparation maintains a high level of effectiveness in controlling the ants' harvesting activities while reducing the amount of insecticide required. It also allows the destruction of the fungus gardens, resulting in a lasting destruction of the nest. In addition, the combined preparation according to the invention is inexpensive and reduces the negative impacts on the environment and human and animal health due to the small quantities of insecticide used. The laccase inhibitor allows an inhibition of the laccase activity present in the garden and in the ants. The laccase inhibitor content allows ant control, and also affects the garden. In addition, the laccase inhibitor content used is easily degradable and environmentally friendly. The use, in addition to the laccase inhibitor, of at least one insecticide with activity against ants, makes it possible to quickly stop the ants' harvesting activity. In addition, it was observed that the combined use of at least one insecticide and at least one laccase inhibitor surprisingly increases the kinetics of the effect of the laccase inhibitor on the fungus. Also, the effect of the insecticide on the ants is increased and acts more quickly. This leads to the destruction of the colony and in particular of the adult ants, to the accelerated decline of the garden and thus to the perennial destruction of the nest. Thus, the combination of a laccase inhibitor with an insecticide allows, on the one hand, to optimize the long-term disappearance of the colony by an effective action on all the actors of the colony as well as on the garden.

More particularly, the invention further relates to a combined formicide preparation comprising, formulated separately or in a single composition, at least one insecticide belonging to the phenylpyrazole, neonicotinoid or sulfonamide family and at least one laccase inhibitor selected from: an antioxidant molecule, a chelator, a detergent, a non-oxidizing organic acid and a cationic metal, said laccase inhibitor being present in the preparation at a content greater than or equal to 0.5% by weight of the preparation, and the mass ratio between the at least one laccase inhibitor and the at least one insecticide being greater than or equal to 2.

According to other optional features of the combined preparation:
the at least one insecticide is selected from: fipronil, sulfluramide or a mixture thereof. Fipronil and sulfluramide allow to quickly stop the ants' harvesting activity by a fast and effective action on the harvesters. In addition, sulfluramide is inexpensive, has high efficacy and is of low toxicity or danger to humans.
the mass ratio between the at least one laccase inhibitor and the at least one insecticide is greater than 5, preferably greater than or equal to 10. Such a mass ratio between the at least one laccase inhibitor and the at least one insecticide makes it possible to couple their effects and to obtain a rapid elimination of the ants, the destruction of the colony as a whole, as well as an absence of the reappearance of the colonies.
the insecticide content in the preparation is less than or equal to 0.3% by weight, preferably less than or equal to 0.1%. At these concentrations, for example, sulfluramide has a lower toxicity for humans and the environment.
the at least one laccase inhibitor is selected from: an antioxidant molecule, a chelator, a detergent, a non-oxidizing organic acid and a cationic metal. These molecules allow an inhibition of the laccase activity and thus contribute, among other things, to the destruction of the fungus garden.
the at least one laccase inhibitor is selected from: glutathione, L-cysteine, sodium thiosulfate, ascorbic acid, eugenol and mixtures thereof. These molecules are rapidly biodegradable and have a strong anti-laccase activity. Preferably, the at least one laccase inhibitor is selected from: L-cysteine, ascorbic acid and mixtures thereof. More preferably the at least one laccase inhibitor is ascorbic acid.
the at least one laccase inhibitor is ascorbic acid or L-cysteine, and the at least one insecticide is fipronil, sulfluramide or a mixture thereof.
the content of the laccase inhibitor in the preparation is greater than or equal to 1% by weight of the preparation, preferably it is between 1 and 10%, inclusive. Furthermore, the content of the laccase inhibitor in the preparation is typically less than or equal to 10% by weight of the preparation. Such a content of the laccase inhibitor allows, in combination with an insecticide, to affect both the garden and the different social categories of ants.
the at least one laccase inhibitor is selected from L-cysteine and ascorbic acid, and the at least one insecticide is fipronil and/or sulfluramide. Preferably, the at least one laccase inhibitor is ascorbic acid, and the at least one insecticide is sulfluramide.
the preparation further comprises a palatable agent. The use of a palatable agent increases the number of ants ingesting the combined preparation and/or increases the spread of the combined preparation to the entire colony and thus increases the exposure of the ants and the fungus garden to the combined preparation.
the palatable agent is selected from: an oligosaccharide palatable agent, a polysaccharide palatable agent and mixtures thereof.
the at least one laccase inhibitor and the at least one insecticide are part of a single composition.

The invention further relates to a method of controlling fungus-growing ants, comprising the use of a combined preparation according to the invention. Such a method makes it possible to protect crops by destroying nests and preventing their development in or near the fields and crops to be protected. In addition, such a method is particularly suitable for controlling fungus-growing ants, as it targets both the colony members and the garden, is inexpensive and environmentally friendly.

The invention also relates to a method of producing a combined preparation according to the invention comprising the following steps:
a dosing step,
a mixing step, and
a shaping step.

Such a production method is simple to implement, inexpensive and allows to protect the crops by preventing the development of nests in or around the fields to be protected and to destroy the colonies of fungus-growing ants.

### FIGURES

FIG. 1: Diagram of a sub-colony such as those used for the calibrated tests of the preparations of the invention. The garden part (A) is connected via a tunnel (C) to the fungus farm part (B) where the fungus (1) is sheltered under a bell (D) as well as a watering place (E), with the ants (2) going from the garden to the fungus farm via the tunnel.

FIG. 2: Decrease in volume of the fungus garden over time. The decrease in volume is expressed as a percentage of the volume of the garden measured at T=0. Prep. 1: preparation containing 1% cysteine (laccase inhibitor); Prep. 3: preparation containing 1% cysteine (laccase inhibitor) combined with 0.075% sulfluramide; Prep. 6: preparation containing 0.075% sulfluramide; Prep. 4: preparation containing 0.3% sulfluramide. The gray dotted horizontal line marks the 50% level of volume decrease of the fungus.

FIG. 3: Cumulative mortality of ants over time. Prep. 4: preparation containing 0.3% sulfluramide; Prep. 5: preparation containing 0.1% sulfluramide; Prep. 7: preparation containing 1% ascorbic acid (laccase inhibitor); Prep. 8: preparation containing 1% ascorbic acid (laccase inhibitor) combined with 0.1% sulfluramide. The gray dotted horizontal line marks the 50% mortality level.

### DETAILED DESCRIPTION

In the following description, by “fungus-growing ants” is meant the ants belonging to the Attini tribe, and in particular to the genera Atta or Acromyrmex. The most represented species are Acromyrmex ambiguus, Acromyrmex aspersus, Acromyrmex balzani, Acromyrmex biscutatus, Acromyrmex coronatus, Acromyrmex crassispinus, Acromyrmex diasi, Acromyrmex disciger, Acromyrmex evenkul, Acromyrmex fracticornis, Acromyrmex heyeri, Acromyrmex hispidus, Acromyrmex hystrix, Acromyrmex landolti, Acromyrmex laticeps, Acromyrmex lobicornis, Acromyrmex lundii, Acromyrmex niger, Acromyrmex nobilis, Acromyrmex octospinosus, Acromyrmex pulvereus, Acromyrmex rugosus, Acromyrmex silvestrii, Acromyrmex striatus, Acromyrmex subterraneus, Acromyrmex versicolor, Atta bisphaerica, Atta capiguara, Atta cephalotes, Atta columbica, Atta dissimilis, Atta domicola, Atta goiana, Atta insularis, Atta laevigata, Atta mexicana, Atta opaciceps, Atta robusta, Atta saltensis, Atta sexdens, Atta sexdens rubropilosa, Atta silvae, Atta texana, Atta vollenweideri. These ants are also known in the prior art as “leafcutter” ants, cassava ants or parasol ants.

Within the meaning of the invention, the expression “control of fungus-growing ants” corresponds here to an action leading to the abandonment of the nest and/or the destruction of the colony.

The expressions “anthill” and “nest” can be used interchangeably here. They correspond to the structure sheltering the colony of fungus-growing ants.

By “colony” is to be understood a group of ants, other than a single pair and including at least one queen, building nests to raise offspring therein in a cooperative manner.

By “garden”, also called “fungus garden” in the literature, is to be understood the fungal structure cultivated by fungus-growing ants and composed mainly of the saprophytic basidiomycete fungus Leucophorus gongylophorus growing on the plant material harvested by the ants. “Garden”, “fungus garden” or “fungus” are used interchangeably here.

By “combined formicide preparation” is to be understood a preparation that is formulated to target the fungus-growing ants and fungus garden, the surprising potentiation effects of which resulting from the combination of the insecticide and the laccase inhibitor allow, among other things, a reduction in the doses of insecticides introduced into the environment. Thus, advantageously, the combined formicide preparation according to the invention has little or no impact on bees or other invertebrates. The combined formicide preparation may comprise these active ingredients formulated separately or in a single composition.

By “laccase” is to be understood polyphenol oxidase type enzymes. They allow the degradation of lignin and provide protection against the toxicity of certain polyphenols. In the nomenclature relating to enzymes, laccases are grouped under the code EC 1.10.3.2. The laccases found in or on fungus garden of fungus-growing ants and in or on fungus-growing ants are particularly targeted.

By “laccase inhibitor” or “compound with laccase inhibitory activity” is to be understood a compound inhibiting the activity of laccases as measured for example by the substrate ABTS (2,2′-azino-bis(3-ethylbenzothiazoline-6-sulfonic acid) according to the method published by Bourbonnais et al. (1990).

By “antioxidant molecule” is to be understood the common meaning given to this term, namely a molecule capable of reducing or preventing the oxidation of other chemical substances. The antioxidant potential of a molecule can be verified for example via the use of ABTS radicals (Bourbonnais et al., 1990).

By “palatable agent” or “bait” is to be understood a compound having an attractive power on fungus-growing ants and thus increasing the amount of the preparation according to the invention collected by said ants. By carbohydrate palatable agent is to be understood a molecule belonging to the carbohydrate group. By oligosaccharidic or polysaccharidic palatable agent is to be understood a molecule of the oligosaccharid or polysaccharid type, for example fructans, glucans, galactans, mannans or hemicelluloses.

The crops protected from infestation and degradation by fungus-growing ant colonies by the use of the combined preparation according to the invention are preferably all plant crops of socio-economic interest for human activity. For example, it can be any agricultural crop (forestry, cereals, fruit trees, flowers, fodder crops) or amenity crops such as gardens.

According to a first aspect, the invention relates to a combined preparation comprising at least one insecticide and at least one laccase inhibitor, said laccase inhibitor being present in the preparation at a content greater than or equal to 0.5% by weight of the preparation.

There is a wide variety of laccase inhibitors.

In particular, any molecule which, in the above-mentioned combined preparation, results in a decrease in laccase activity of more than 50%, preferably more than 75%, more preferably more than 90%, is considered a laccase inhibitor. Preferably, these inhibitions of laccase activity are obtained at laccase inhibitor contents of less than 10% by weight of the preparation. Even more preferably, these inhibitions of laccase activity are obtained at contents of less than or equal to 5% by weight of the preparation.

All antioxidant molecules have the ability to inhibit the activity of a laccase. Nevertheless, there are laccase inhibitors that do not have antioxidant activity. Among the molecules having an anti-laccase activity and not being antioxidant molecules, it is possible to mention chelators, detergents, non-oxidizing organic acids and cationic metals. For example, the following are also molecules with anti-laccase activity without being antioxidant molecules: ethylene diamine tetraacetic acid (EDTA), calcium chloride (CaCl₂), rhodotorulic acid, enterobactin, thioglycolic acid, diethyldithiocarbamic acid, sodium azide, cetyltrimethylammonium bromide, Fe²⁺, Cu²⁺, Ag⁺, Li⁺, Sn⁺, Hg⁺, Mn²⁺, Zn²⁺, Al³⁺, sodium lauryl sulfate, sodium cyanide (NaCN), sodium thiosulphate, oxalic acid and beta-mercaptoethanol.

Thus, at least one laccase inhibitor is selected from: an antioxidant molecule, a chelator, a detergent, a non-oxidizing organic acid and a cationic metal.

The preferred molecules for use as laccase inhibitors are:
for chelators: EDTA, rhodotorulic acid, enterobactin
for detergents: sodium lauryl sulfate,
for cationic metals: Fe²⁺, Cu²⁺, Ag⁺, Li⁺, Sn⁺, Hg⁺, Mn²⁺, Zn²⁺, Al³⁺,
for non-oxidizing organic acids: oxalic acid, thioglycolic acid, diethyldithiocarbamic acid.

Preferably, the laccase inhibitor is an antioxidant molecule.

Such antioxidant molecules are generally known to the one skilled in the art (Lu et al., 2010). He/she can also verify this activity via classical tests for measuring antioxidant potential such as the one described in Bourbonnais et al. (1990).

Molecules with anti-laccase activity and antioxidant activity can for example be selected from: ascorbic acid (E300), citric acid (E330), coumaric acid, ferulic acid, gallic acid, 6-O-palmitoyl-L-ascorbic acid (E304), syringic acid, sodium/calcium/potassium ascorbates (E301)/(E302)/(E303), butylhydroxyanisole (BHA), butylhydroxytoluol, cysteine, octyl (E311) or dodecyl (E312) gallates, glutathione, sodium/potassium/calcium lactates (E325)/(E326)/(E327), lecithins (E322), lipoate, carotenoids (E160) such as lutein, luteolin, carotenes such as lycopene, sodium (E335)/potassium (E336) or sodium and potassium (E337) tartrates, eugenol, sodium thiosulfate, vitamin E (natural tocopherols (E306)), synthetic α-tocopherol (E307), synthetic γ-tocopherol (E308) and synthetic δ-tocopherol (E309), selenium and hydroxylammonium chloride. In particular, the laccase inhibitor is selected from one of the following compounds: ascorbic acid, citric acid (E330), coumaric acid, 6-O-palmitoyl-L-ascorbic acid (E304), sodium/calcium/potassium ascorbates (E301)/(E302)/(E303), L-cysteine, octyl (E311) or dodecyl (E312) gallates, glutathione, sodium (E325), potassium (E326) or calcium (E327) lactates, lecithins (E322), carotenoids (E160) such as lutein, luteolin, carotenes such as lycopene, sodium (E335)/potassium (E336) or sodium and potassium (E337) tartrates, eugenol, sodium thiosulfate, vitamin E (natural tocopherols (E306)), synthetic α-tocopherol (E307), synthetic γ-tocopherol (E308) and synthetic δ-tocopherol (E309), selenium and hydroxylammonium chloride. The laccase inhibitor preferably has little impact on the environment and is rapidly degraded therein. Thus, preferably the laccase inhibitor is selected from one of the following compounds: ascorbic acid, sodium/calcium ascorbates (E301)/(E302), sodium/potassium/calcium lactates (E325)/(E326/(E327), lutein, lycopene, sodium (E335)/potassium (E336) or sodium and potassium tartrates (E337), sodium thiosulfate, vitamin E (natural tocopherols (E306)), synthetic α-tocopherol (E307), synthetic γ-tocopherol (E308) and synthetic δ-tocopherol (E309), L-cysteine and glutathione. Preferably, the laccase inhibitor is selected from one of the following compounds: L-cysteine, coumaric acid, glutathione, eugenol, sodium thiosulfate, ferulic acid, syringic acid, ascorbic acid, gallic acid.

In addition, the preferred molecules are natural or easily degradable and are therefore environmentally friendly. Thus, even more preferably, the laccase inhibitor is selected from one of the following compounds: L-cysteine, glutathione, eugenol, sodium thiosulfate, ferulic acid, syringic acid, ascorbic acid and gallic acid.

Particularly preferably, the laccase inhibitor is selected from L-cysteine, ascorbic acid, sodium thiosulfate, glutathione, eugenol and mixtures thereof. Even more preferably, the laccase inhibitor is selected from L-cysteine and ascorbic acid or mixtures thereof.

This laccase inhibitor is used at a concentration sufficient to cause inhibition of the activity of laccases present in the garden and in ants.

This concentration can be determined by the one skilled in the art using conventional minimum inhibitory concentration tests. Typically, the laccase inhibitor is present in the preparation at a content greater than or equal to 0.25% by weight of the preparation. Preferably, the laccase inhibitor is present at a content greater than or equal to 0.5%, and even more preferably at a content greater than or equal to 1%. Furthermore, the content of the laccase inhibitor in the preparation is less than 10% by weight of the preparation. For example, the content of the laccase inhibitor in the preparation is between 0.25 and 15% by weight, inclusive, of the preparation, more preferably between 0.5 and 10% by weight, inclusive, of the preparation, and even more preferably between 1 and 5% by weight, inclusive, of the preparation.

This laccase inhibitor allows an inhibition of the laccase activity present in the garden and the ants. In addition, the laccase inhibitor content used is easily degradable and environmentally friendly.

As presented in the experimental section, the use of at least one laccase inhibitor has activity on the garden. However, this action is not immediate and does not quickly stop the ants' harvesting activity, which can also move the nest. Thus, it is necessary to be able to also target the ants of the colony.

Thus, still according to the first aspect of the invention, the invention relates to a combined preparation comprising at least one insecticide and at least one laccase inhibitor, said laccase inhibitor being present in the preparation at a content greater than or equal to 0.5% by weight of the preparation.

Advantageously, the use, in addition to the laccase inhibitor, of at least one insecticide having activity against ants allows the destruction of the colonies around the location of the combined preparation by reducing the risk of the colonies reappearing. Indeed, it was observed that, surprisingly, the combination of at least one insecticide and at least one laccase inhibitor has an earlier and much greater inhibitory effect on the growth of the fungus than the laccase inhibitor used alone. This is all the more surprising since no effect is observed on the fungus when the insecticide is used as the only active agent, at the same concentrations as those used in the combined preparation of the invention. The fungus is essential for the colony because it provides food for the adult ants and larvae by degrading the plants harvested by the ants. In addition, the garden is the location of the larvae which are covered with mycelium by the workers, for protection and/or food supply. It is known that the garden secretes numerous enzymes of fungal origin which can reduce the effectiveness of insecticides, on the one hand, and act on adult ants, on the other hand. It is also known from the prior art that larvae have an essential role in the colony: a colony lacking larvae quickly dies out due to the disorganization of the workers (lopes et al. 2005). Thus, brought by the ants in the fungus garden, the combined preparations of the invention will cause the rapid decline of the fungus, the source of food for the worker ants and larvae, which results in the death of the ants and larvae. This implies a non-renewal of the populations and thus decreases the risks of the resurgence of the nests.

Besides the lack of food, ants and larvae are also targeted by the insecticide. Also surprisingly, as demonstrated in the experimental section, the combination of at least one insecticide and at least one laccase inhibitor has a faster formicide effect on ants in the colonies than the insecticide used alone, yet at higher concentrations. A surprising potentiation of the effect of the insecticide within the combined preparations is thus observed, resulting in an identical global mortality despite a decrease in the quantities of insecticide and also a decrease in the time of action of the insecticide.

Such a synergistic effect on the fungus, associated with the combination of effects on the different actors of the colony, at the same time and in a very limited time due to the potentiation of the insecticide, thus results in the effective destruction of the nest and the colony. In addition, the risk of the colony changing location is greatly reduced, as the adult ants are targeted by the rapid insecticidal activity of the preparation combined with the lack of food that also occurs rapidly due to the decline of the garden. Similarly, the risk of the colony reforming from remaining larvae and/or fungus is low as these are also targeted. Thus, the combination of a laccase inhibitor with an insecticide allows, on the one hand, to optimize the disappearance of the colony and, on the other hand, to avoid the appearance of new colonies.

Furthermore, the mass ratio between the at least one laccase inhibitor and the at least one insecticide in the combined preparation according to the invention is greater than or equal to 2, preferably greater than or equal to 5, more preferably greater than or equal to 10, particularly preferably greater than or equal to 30, and even more preferably greater than or equal to 50. For example, the mass ratio between the at least one laccase inhibitor and the at least one insecticide in the combined preparation according to the invention is between 2 and 10,000, between 5 and 5,000, preferably between 10 and 15,000, preferably between 30 and 500, more preferably 50 and 300, inclusive.

Such a mass ratio between the at least one insecticide and the at least one laccase inhibitor achieves the unexpected effects on the garden and ant mortality described above. It allows to obtain the elimination of the ants and the destruction of the garden which prevents the reappearance of the colonies, contrary to the traditional insecticide treatments, for which a change of location of the nests can be observed.

There is a wide variety of insecticides such as those belonging to the phenylpyrazole, neonicotinoid and sulfonamide families.

As mentioned, the use of an insecticide is particularly effective in stopping the ants' harvesting activity by killing the ants quickly while optimizing the destruction of the fungus-growing ants' nest by allowing an accelerated decline of the garden.

The combined preparation according to the invention is characterized in that the at least one insecticide belongs to the phenylpyrazole, neonicotinoid or sulfonamide family.

In particular, the combined preparation according to the invention is characterized in that the at least one insecticide is selected from fipronil, sulfluramide or a mixture thereof.

Fipronil or (RS)-5-amino-1-[2,6-dichloro-4-(trifluoromethyl)phenyl]-4-(trifluoromethylsulfinyl)pyrazole-3-carbonitrile (C₁₂H₄Cl₂F₆N₄OS) is a broad-spectrum insecticide belonging to the phenylpyrazole family. It acts on the central nervous system and more precisely on gamma aminobutyric acid (GABA), the main neurotransmitter and neuromodulator in insects. Fipronil has a direct mode of action by simple contact or ingestion and an indirect effect by horizontal transfer of toxicity by necrophoresis, grooming and trophallaxis.

The sulfluramide or N-ethylperfluorooctylsulfonamide (C₁₀H₆F₁₇NO₂S) is an insecticide that, when present in the body, is metabolized to form a perfluorooctane sulfonamide compound (DESFA) which is involved in the oxidative phosphorylation process (aerobic respiration), interrupting the production of ATP in the mitochondria as opposed to dechlorane which acts on the nervous system. DESFA blocks proton coupling in oxidative phosphorylation preventing ATP production and is therefore lethal to ants. Sulfluramide intoxication causes, among other things, a strong decrease of the energy of the ants' organism until the interruption of the metabolism leading to the death of the ants.

Classically used, these insecticide treatments have the disadvantage of causing an alert phenomenon in the ants which then move the colony and the nest. The combined preparation according to the invention allows a rapid effect on the ants and the colony and the accelerated decline of the garden, thus preventing the colony from moving. Furthermore, sulfluramide is inexpensive, has a high efficacy and is of low toxicity or danger to humans, especially since, still in the combined preparation according to the invention, the doses used can be lower than the usual indicated doses for these insecticides used alone.

In particular, in the present combined preparation according to the invention, a mixture of fipronil and sulfluramide can be used as an insecticide within the meaning of the invention. This allows coupling both the effects of fipronil with the effects of sulfluramide.

As demonstrated in the experimental section, the combined preparations according to the invention comprise significantly lower quantities of insecticide compared to conventional insecticide treatments, while providing a more rapid lethal effect and without decreasing the overall mortality, which is particularly advantageous from the point of view of the environment and the toxicity for humans. Nevertheless, depending on the characteristics of the insecticide, it may also be decided to maintain a conventional amount of insecticide, as the combined preparations of the invention increase their formicide effect. Thus, the insecticide content can be divided by a factor greater than or equal to 1, preferably by a factor greater than or equal to 2, and even more preferably by a factor greater than or equal to 3, compared to the prescribed treatment for the insecticide used alone.

The insecticide content in the preparation is less than or equal to 0.3% by weight, preferably less than or equal to 0.15% by weight, more preferably less than or equal to 0.1% by weight of the preparation. For example, the insecticide is used in a formicide preparation at a concentration of between 0.001% and 0.3% by weight, inclusive, of the preparation. Preferably, it is between 0.01 and 0.1% by weight, inclusive, and more preferably between 0.02 and 0.075% by weight, inclusive, of the preparation.

Thus, at this concentration, for example, sulfluramide has low toxicity for humans and the environment. In addition, if a mixture of insecticides is used, the total insecticide content can be further reduced. It is less than or equal to 0.1%, preferably less than or equal to 0.075% by weight of the preparation, which makes it possible to keep a high effectiveness for the destruction of ants while still decreasing the toxicity for humans and the environment.

Depending on the usual doses used for these insecticides, for other insecticides this concentration may be even lower. For example, for fipronil, it can be less than or equal to 0.1% by weight, preferably less than or equal to 0.01% by weight of the preparation, even more preferably less than or equal to 0.003% by weight of the preparation, particularly preferably less than or equal to 0.001% by weight of the preparation.

The different contents, concentrations and mass ratios can be determined by the one skilled in the art using conventional concentration evaluation tests.

Preferably, the at least one laccase inhibitor is L-cysteine and the at least one insecticide is fipronil, sulfluramide or a mixture thereof. Indeed, L-cysteine is a powerful inhibitor of phenol oxidases and its use combined with fipronil or sulfluramide leads to an accelerated decline of the colony, and increases the effectiveness of fipronil or sulfluramide in terms of toxicity for the ants of the colony, which results in the death of the colony, without the nest moving or new colonies or nests reappearing.

More preferably, the at least one laccase inhibitor is ascorbic acid and the at least one insecticide is fipronil, sulfluramide or a mixture thereof. Indeed, ascorbic acid is also a potent inhibitor of phenol oxidases its use combined with fipronil and/or sulfluramide in terms of toxicity to the ants in the colony, results in the death of the colony, without the nest moving or new colonies or nests reappearing.

According to an embodiment of the invention, the combined preparation further comprises a palatable agent. Indeed, the use of a palatable agent makes it possible to attract the fungus-growing ants more effectively, as opposed to the absence of a palatable agent.

Thus, the use of a palatable agent increases the number of ants ingesting the combined preparation or increases the import of the combined preparation into the colony, particularly on the fungus, and thus increases the exposure of the ants and the garden to the combined preparation.

In particular, the combined preparation according to the invention is characterized in that the palatable agent is selected from an oligosaccharide palatable agent, a polysaccharide palatable agent, and mixtures thereof.

In particular, the oligosaccharide or polysaccharide palatable agent may be selected from: starch, amylose, amylopectin, cellobiose, glycogen, glucose, sucrose, laminarin ((1-3)-beta-D-glucan), maltodextrin, cyclodextrin polymers, isomaltose polymers, icodextrins, dextran, maltoheptose, maltohexose, maltopentose, maltotetrose, maltotriose, maltobiose, cellulose, hemicellulose, holocellulose, lignocellulose, cellulose ethers, cellulose esters, alkyl cellulose, hydroxy cellulose, levoglucosan, pectin, pectocellulose, microcrystalline cellulose, powdered cellulose, paper, wood fiber, derivatives and mixtures thereof.

Preferably, the oligosaccharide or polysaccharide palatable agent is selected from: starch, amylose, cellobiose, laminarin, maltodextrin, maltobiose, glucose, sucrose, glycogen, cellulose, hemicellulose, holocellulose, lignocellulose, cellulose ethers, cellulose esters, alkyl cellulose, hydroxy cellulose, levoglucosan, pectin, pectocellulose, derivatives and mixtures thereof.

Particularly preferably, the oligosaccharide or polysaccharide palatable agent is selected from: starch, amylose, laminarin, maltodextrin, glycogen, cellulose, hemicellulose, holocellulose, lignocellulose, cellulose ethers, cellulose esters, alkyl cellulose, hydroxy cellulose, levoglucosan, pectin, pectocellulose, derivatives and mixtures thereof.

Even more preferably, the palatable agent is starch or cellulose.

In particular, the oligosaccharide or polysaccharide palatable agent may be a cereal flour or cereal grits or a mixture of flours or grits from different cereals, such as, for example, wheat or corn flour, wheat grits, oat grits or corn grits.

Even more particularly, the oligosaccharide or polysaccharide palatable agent can be a fruit puree or a mixture of fruit purees or a composition based on fruit pulp or a mixture of fruit pulps, such as citrus or banana.

Preferably, the oligosaccharide or polysaccharide palatable agent is a mixture of cereal flour or grits or a mixture of flours or grits from different cereals such as, for example, those mentioned above, and fruit puree or a mixture of fruit puree or a composition based on fruit pulp or a mixture of fruit pulps or fruit pulp derivatives (e.g. dehydrated pulp).

Typically, the concentration of the palatable agent is a function of the presence and amount of the laccase inhibitor and/or the insecticide. Thus, the amount of palatable agent is between 600 g/kg and 999 g/kg; preferably between 800 g/kg and 999 g/kg, more preferably between 850 g/kg and 990 g/kg, or even between 870 g/kg and 950 g/kg of the formicide preparation.

Advantageously, the combination of the at least one laccase inhibitor and the at least one insecticide in the combined preparations of the invention has no repellent effect on ants, particularly when used in combination with an oligosaccharide or polysaccharide palatable agent as described above, as demonstrated in the experimental section.

It is possible to use the at least one laccase inhibitor and the at least one insecticide of the combined formicide preparation according to the invention simultaneously, jointly or separately, in one or more dispersions. The preparation according to the invention can be dispersed in one go on or around the nest or in the vicinity of the crop columns.

In a particular embodiment, the preparation according to the invention is dispersed evenly, in several times, over a period of time or at defined intervals, on or around the nest or in the vicinity of the crop columns. For example, the dispersions can be carried out every 5 to 10 days. Typically the dispersions can be daily, or 2, 3, 4, 5, or 6 days apart, or one, two or three weeks apart. The preparation according to the invention can be dispersed directly on or around the nest when the latter is localized (e.g. within 5 meters) or preferably close to the crop columns (e.g. within 2 meters).

According to one alternative, the at least one laccase inhibitor and the at least one insecticide are formulated separately as active compounds in the combined preparation against fungus-growing ants. Thus, according to this alternative, a formulation comprising the laccase inhibitor will be combined with a formulation comprising the insecticide, in doses and ratios as described above. Preferably, these two compounds are the only compounds active against fungus-growing ants in said combined preparation. That is to say, they are the only ones that act negatively directly on the members of the colony and/or the fungus. The advantage of this alternative is that the quantities of each of the active agents in the preparation can be adjusted independently of each other.

According to a preferred alternative, the at least one laccase inhibitor and the at least one insecticide are part of a single composition as active compounds against fungus-growing ants. Preferably, these two compounds are the only compounds active against fungus-growing ants. That is to say, they are the only ones that act negatively directly on the members of the colony and/or the fungus.

The combined preparation according to the invention can take different forms. Thus, the combined preparation takes a form selected from: one or more pellets or one or more powders.

For example, the combined preparation according to the invention may comprise pellets comprising the laccase inhibitor, pellets comprising the laccase inhibitor and the insecticidal compound, or pellets comprising the laccase inhibitor combined with pellets comprising the insecticidal compound or pellets comprising the insecticidal compound. The combined preparation may comprise one or more powders such as a powder comprising the laccase inhibitor, a powder comprising the laccase inhibitor and the insecticidal compound, or a powder comprising the laccase inhibitor combined with a powder comprising the insecticidal compound or a powder comprising the insecticidal compound. Also, the combined preparation according to the invention may comprise pellets comprising one of the active agents and a powder comprising another of its active agents. These types of forms are suitable for a direct mode of action by simple contact or ingestion and for an indirect mode of action by horizontal transfer of toxicity. In addition, the pellets or powders can be dispensed by a hand pump or by an automatic dispensing device capable of dispensing a defined quantity. This makes spreading particularly simple and easy and can also be done in a localized and targeted manner (compared to spraying, for example), especially with pellets. Alternatively, the pellets can be deposited in a container in which one or more passages are provided for the ants, allowing them to pick up the pellets and import them into the colony. This type of treatment has the advantage of protecting the treatment from climatic conditions such as rain or wind, and therefore allows the treatment to be renewed less often. These forms do not require specific equipment, on the contrary, they are practical and economical. Moreover, the use of the preparations of the invention in granular form limits the risks of contamination of the operator by the insecticides contained in the preparations, as well as the risks of uncontrolled dissemination in nature by the wind, for example.

According to another aspect, the invention relates to a method of controlling fungus-growing ants comprising the use of a combined preparation according to the invention. Such a method makes it possible to protect crops by preventing the development of nests in the vicinity of the fields and crops to be protected. In addition, such a method is particularly adapted to fungus-growing ants because of its effects explained above, and is also inexpensive and more respectful of the environment than conventional solutions based only on chemical insecticides, because of the nature, the quantity of its components, and its form. Preferably, the method according to the invention comprises the use of a combined preparation according to the invention at concentrations and/or mass ratios making it possible to obtain, in particular, in addition to its numerous advantages inherent in the combination of effects particularly suitable for controlling fungus-growing ants, the synergistic effect observed by the inventors on the growth of the fungus of the garden and the effect of potentiating the toxicity of the insecticide on the ants of the colony and its speed of action.

These new methods of ant control and the associated combined preparations comprising at least one insecticide and at least one laccase inhibitor are particularly suitable for fungus-growing ants, they have a lower impact on the environment than conventional formicide compositions. Further, in some embodiments, these compositions are rapidly degraded.

The preparation can be dispensed indirectly on or around the nest or preferably near the crop columns. The amount of preparation dispensed is between 1 g and 200 g per square meter, preferably between 2 g and 100 g per square meter, and even more preferably 4 g and 50 g per square meter, particularly preferably 8 and 45 g per square meter, inclusive. Indeed, the quantity dispensed can vary according to the surface area of the nest or simply the surface area one wishes to treat. The one skilled in the art knows how to determine the surface to be treated.

Advantageously, the laccase inhibitor and the insecticide are dispensed separately in the control method of the invention, this allows the respective concentrations of the active compounds to be varied, in particular depending on where the preparation of the invention is deposited and on a particular target, that is to say on or near the nest, near the crop columns, on or near the plants or the target: the castes of ants (minor, major, medium, larvae . . . ) or the fungus garden.

In the method of controlling fungus-growing ants of the invention, the combined preparation can also be formulated together, in granular or powder form, as described above and spread manually and/or automatically.

According to another aspect, the invention also relates to a method of producing a combined preparation according to the invention comprising the following steps:
a dosing step,
a mixing step, and
a shaping step.

The dosing step includes measuring a predetermined amount of at least one insecticide and at least one laccase inhibitor. The dosage corresponds to providing a composition comprising at least one insecticide and a composition comprising at least one laccase inhibitor in defined contents to obtain the combined preparations of the invention at the contents, concentrations and/or mass ratios as described above or providing a single composition comprising a laccase inhibitor and an insecticide also defined to obtain the combined preparations of the invention at the contents, concentrations and/or mass ratios as described above. Technically providing a dosage is established in a common way according to the one skilled in the art.

The mixing step comprises incorporating the at least one laccase inhibitor and the at least one insecticide homogeneously, separately or together in a matrix, said matrix being a suitable excipient for shaping the combined preparation. Advantageously, at least one palatable agent is added during this step in the concentrations described. Even more advantageously, the at least one palatable agent constitutes the matrix.

Optionally, one or more evaporation steps of the solvents in which the weakly water-soluble active compounds would be dissolved can be applied. The duration of each step can vary according to the solvent used; the one skilled in the art will easily know how to determine the total evaporation of the one or more solvents.

The production method also includes a step of shaping in the form of pellets or a powder. The pellets may comprise the laccase inhibitor or the insecticidal compound, may comprise the laccase inhibitor and the insecticidal compound, or pellets may comprise the laccase inhibitor combined with pellets comprising the insecticidal compound. Advantageously, said pellets are of a size adapted so that the harvesting ants can bring them back to the colony, in the nest. Even more advantageously, the size of the pellets is suitable for transport regardless of the size of the ant among the different castes of ants in the colony, thus promoting the importation and dispersion of the pellets and thus the composition within the colony. The one skilled in the art can easily determine the appropriate size of the pellets. For example, the pellets may be similar in size to a grain of rice, typically about 5 mm long and 1 to 2 mm wide. Of course, any shape can be suitable, the criterion being that said pellet is transportable by ants as mentioned above.

The combined preparation may also take the form of powders such that the powder may comprise the laccase inhibitor or may comprise the laccase inhibitor and the insecticidal compound or may comprise the laccase inhibitor combined with a powder comprising the insecticidal compound.

Optionally, the shaping step comprises binding, for example with water or any other acceptable solution or liquid (such as soybean oil) not having a repellent effect on ants, the mixture resulting from the mixing step, so as to obtain the desired consistency to allow proper shaping, in the case of pellets, for example. Advantageously, the binder may itself constitute or comprise a palatable agent for ants.

Optionally, the powder or pellets obtained are dried before storage.

### EXAMPLE

The combined preparation according to the invention was tested in the form of pellets comprising a combination of a microdosed insecticide (sulfluramide or fipronil) with a laccase inhibitor (cysteine or ascorbic acid), on sub-colonies of fungus-growing ants. These sub-colonies are calibrated, which ensures the good comparability of the different conditions tested.

The tests carried out are in accordance with the normative instructions n^{o} 36 of Nov. 24, 2009, issued by the Brazilian Ministry of Agriculture, Livestock and Supply (MAPA), in the framework of the development of leafcutter ant control methods.

Material and Methods

Sub-Colonies of Fungus-Growing Ants

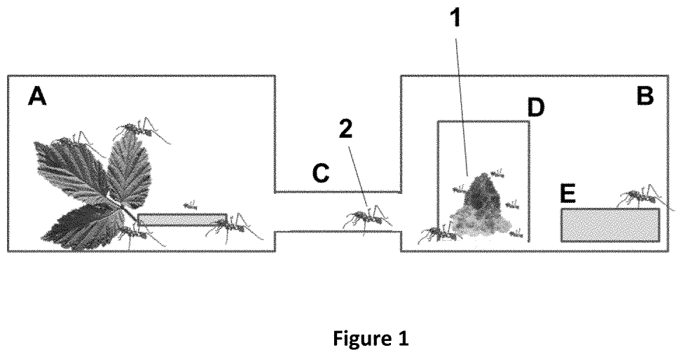

The tests are carried out on sub-colonies of ants which are derived from colonies of Atta cephalotes from Trinidad. These sub-colonies are calibrated and constituted by associating 20 medium workers+20 minor workers and a fungus garden of about 3 cm³ at the beginning of the experiment, placed in an enclosure as described in FIG. 1: Each sub-colony has a fungus farm part and a “garden” part in which plants are renewed at will according to their consumption by the ants (see FIG. 1).

All the tests are carried out on colonies called stabilized colonies, for which, following the installation, no more mortality is observed, and which have started the harvesting activity. Classically, the stabilization of the colonies can take 5 to 15 days during which the dead ants are replaced.

Combined Preparations Tested and Number of Tests

Unless otherwise stated, concentrations are expressed as mass percentage.

TABLE 1

| | Palatable | Insecticide | Laccase inhibitor | Number |
|---|---|---|---|---|
| Preparation | agent (%) | (mass percentage) | (mass percentage) | of tests |
| Control | 100.000 | — | — | 10 |
| Preparation 1 | 99.000 | — | cysteine (1%) | 5 |
| Preparation 2 | 98.900 | 0.1% sulfluramide | cysteine (1%) | 4 |
| Preparation 3 | 98.925 | 0.075% sulfluramide | cysteine (1%) | 5 |
| Preparation 4 | 99.700 | 0.3% sulfluramide | — | 5 |
| Preparation 5 | 99.900 | 0.1% sulfluramide | — | 5 |
| Preparation 6 | 99.925 | 0.075% sulfluramide | — | 5 |
| Preparation 7 | 99.000 | — | ascorbic acid (1%) | 6 |
| Preparation 8 | 98.900 | 0.1% sulfluramide | ascorbic acid (1%) | 6 |
| Preparation 9 | 98.925 | 0.075% sulfluramide | ascorbic acid (1%) | 5 |
| Preparation 10 | 98.990 | 0.01% fipronil | cysteine (1%) | 4 |
| Preparation 11 | 98.997 | 0.003% fipronil | cysteine (1%) | 5 |
| Preparation 12 | 99.997 | 0.003% fipronil | — | 5 |
| Preparation 13 | 99.990 | 0.01% fipronil | — | 5 |
| Preparation 14 | 99.97 | 0.03% fipronil | — | 5 |
| Preparation 15 | 98.990 | 0.01% fipronil | ascorbic acid (1%) | 6 |
| Preparation 16 | 98.997 | 0.003% fipronil | ascorbic acid (1%) | 5 |
| Preparation 17 | 98.999 | 0.001% fipronil | ascorbic acid (1%) | 5 |

TABLE 2

| | Mass of | Palatable | Insecticide | Laccase inhibitor | Number |
|---|---|---|---|---|---|
| Preparation | pellet | agent (%) | (mass percentage) | (mass percentage) | of tests |
| Preparation 18 | 1 g | 99.900 | sulfluramide 0.1% | — | 5 |
| | 1 g | 99.000 | — | cysteine (1%) | |

Production of the Preparations

In this example, the combined preparations according to the invention as well as the control preparations were prepared in granular form. The different preparations are prepared in semi-sterile conditions, under a fume hood, the containers and tools are disinfected between each preparation.

These pellets are shaped to have the size and shape of a rice grain (that is to say easy to carry by ants, typically 5 mm long and one to two mm wide).

A paste is formed with the different constituents (mass percentage):
The matrix, which also constitutes the palatable agent, consists of a mixture of white wheat flour (such as that classically used in human food), sucrose (10%, D(+)-sucrose, supplier: Labosi)) and citrus powder (10%, citrablend, dehydrated lemon peel powder from organic farming, mesh 80, supplier: Office Couecou, France).
The active components are added at the concentrations as stated in Tables 1 or 2. The laccase inhibitors tested were L-cysteine (L-cysteine hydrochloride, SBM formulation) and ascorbic acid.
Water is added to achieve a satisfactory consistency for shaping.

Depending on the solubility of the tested insecticide, in order to obtain a homogeneous distribution in the pellets, the insecticide is dissolved in the appropriate solvent, before mixing with the other components.

Depending on the solvent used, an evaporation step may be required to evaporate said solvent. Thus, in this example, sulfluramide (supplier: Sigma-Aldrich, ref. 91242) is first diluted in methanol (Normapur grade, supplier: Prolabo) and fipronil (supplier: VWR, ref. SUPL16785-50MG) in acetone (Normapur grade, supplier: VWR), and then mixed with the matrix, the mixture was subjected to evaporation (approximately 48 hours) prior to wetting.

To allow shaping, the preparations were made pasty by adding water (1 ml of water/2 g of preparation for a single composition), and then shaped in the form of pellets as specified above.

For Preparation 18 (Table 2, preparation in which the active ingredients are formulated separately), the insecticide and laccase inhibitor pellets are shaped separately, and subsequently combined. The amount and mass concentrations of each of the formulations are established so as to obtain a combined preparation with the same concentrations and mass ratio between the laccase inhibitor and the insecticide as for Preparation 2.

After shaping, the pellets were dried for 48 h in the fume hood and stored in airtight bottles.

Administering the Combined Preparation to the Colony

At T0 the plant is replaced by a small 3 cm-diameter dish containing 2 g of the preparation to be tested. The dish containing the pellets is left in place for 24 hours, then removed, before putting back the plants.

The quantity of preparation taken by the ants is deduced from weighing the remaining quantity after 24 hours of presence in the colony (weighing is carried out after drying approximately 24 hours at room temperature because of experimental humidity conditions).

Administering the test preparations and measuring always take place at the same time of the day, here in the afternoon between 14:30 and 17:00.

At T0, T+1 and then every 3 days until 21 days, measurements relating the survival of ants, the volume of the fungus and the consumption of plants are made.

Effects Measured on the Fungus:

The decline of the garden is assessed by two aspects: the color of the garden and its volume. The fungus gardens of leafcutter ant colonies under normal conditions are gray or salt-and-pepper in color on at least the upper third. Declining gardens take on a whitish color.

Bleaching Index:

A bleaching index was therefore developed as an indicator of garden decline. It corresponds to the ratio of gray garden height/total garden height; it is a measure of the bleaching of the garden.

Volume Index

The change in volume of each fungus in each colony at a time T is measured by assuming that the fungus has a shape approximating that of a cone and relating the volume measured at time T to the volume measured at T0.

The volume V of the garden is calculated according to the formula:

$$V = \frac{H * {r}^{2} * π}{3}$$

where H is the height of the garden and r is the radius of its base.

Measurement of Ant Mortality

Mortality is the cumulative number of deaths during the trial (that is to say a maximum of 40 over 21 days).

Mortality can also be expressed according to Abott's formula which allows estimating the insecticidal efficacy of the tested preparations (EA, Abott's efficacy), taking into account the existing mortality in the control trials.

EA=(1−(number of deaths−number of deaths in the control)*100

Finally, LD50 also allows estimating the efficiency of the preparations tested, by measuring the time necessary to kill half of the ants of the colony.

Results

Consumption of the Preparations

No significant difference in the consumption of the preparations according to their composition was observed (not shown).

Thus, a good palatability of the ants for the combined preparations of the invention is observed, comparable to the control, without any particular repellent effect due to the presence of the laccase inhibitor and/or the insecticide.

Volume of the Fungus

The average decrease (observed at T21, compared to T0) in the percentage of the volume of the fungus is reported in Table 3.

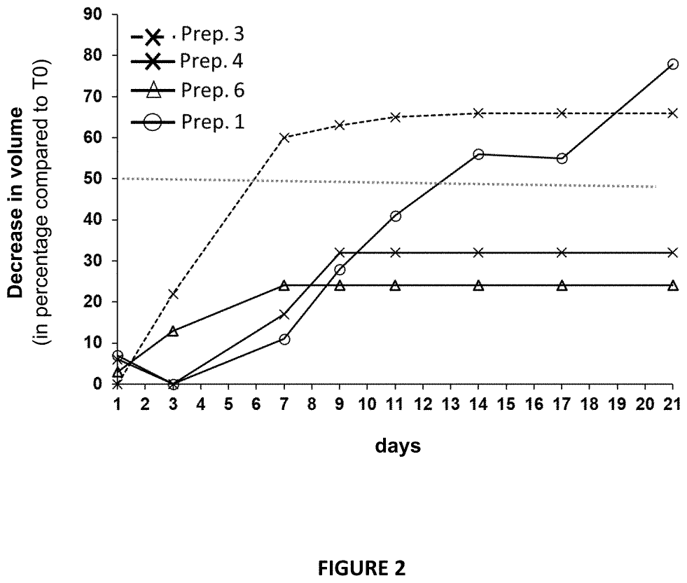

Generally, regular monitoring every three days of the volume of the fungus in the colonies shows that a significant reduction in the volume of the fungus is observed from the third day of the experiment when a combined preparation according to the invention, comprising a laccase inhibitor and an insecticide, is administered to the ant colonies, this being much less when the anti-laccases are used alone. Preparations containing insecticide as the only active agent do not show significant toxicity to the fungus. These results are illustrated in FIG. 2 and Table 3.

TABLE 3
Effect of the combined preparations
of the invention on the fungus garden

| | Decrease in fungus | | |
|---|---|---|---|
| Preparation | volume at T21* | T 50% ^{†} | |
| Control | 43% | na | |
| Preparation 1 | 78% | 13 | days |
| Preparation 2 | 60% | 7.5 | days |
| Preparation 3 | 66% | 6 | days |
| Preparation 4 | 32% | na | |
| Preparation 5 | nd | nd | |
| Preparation 6 | 24% | na | |
| Preparation 7 | 68% | 11 | days |
| Preparation 8 | 72% | Less than 7 days | |
| Preparation 9 | 65% | 7 | days |

*as a percentage of the initial volume
^{†} time (in days) at which 50% decrease in fungal volume is observed.
na: inhibition not achieved.
nd: data not available

A decrease is certainly observed for the preparations containing only the laccase inhibitor (Preparations 1 and 7), but the decrease can be up to twice as fast with the combined preparations according to the invention (e.g. Table 3 and FIG. 2). Compared to the control, no significant toxicity to the fungus is observed for the insecticide used alone (Preparations 4 and 6) and this even when a concentration of insecticide up to 4 times higher is used in comparison with those used in the combined preparations of the invention (Table 3).

For example, a 50% decrease in the volume of the fungus garden is observed just before day 6 of the experiment for the combination of 1% cysteine and 0.075% sulfluramide (Preparation 3), whereas it is necessary to wait 13 days to observe a decrease of the same magnitude for the colonies treated with preparations containing only cysteine. Preparations containing only sulfluramide at the same concentration do not exceed a volume decrease of 24% (FIG. 2). A comparable maximum inhibition of 32% is observed when sulfluramide is used alone at a concentration yet 4 times higher.

Similar to the single formulation preparations, accelerated decline of the fungus is also observed for Preparation 18 which includes the insecticide and the laccase inhibitor in two separate formulations.

Comparable results are observed for Preparations 10 to 17 with fipronil.

Thus, unexpectedly, the combined use of an insecticide and a laccase inhibitor as described in the present invention results in a significant increase in the rate of decrease in fungal volume compared to that caused by the laccase inhibitor used alone, with no significant activity of the insecticide used alone being detected on the volume or color of the fungus when used alone, at the same concentrations.

A method for determining the synergistic effect of herbicidal compounds is mentioned in Colby (1967) and is applicable here. Colby mentions that the expected efficacy E (that is to say the efficacy resulting from a simple additive effect) of the combination of two compounds x and y can be determined according to the formula:

$$E = X + Y - \frac{X Y}{100}$$

where X is the inhibition observed at a given amount of product x, and Y the inhibition observed for a given amount of product y.

When the observed effect is greater than the expected one (calculated by the above formula), then the combination is synergistic, if the effect is less than the expected one, then the combination is antagonistic, if the effect is identical, then the combination is additive.

TABLE 4

| | T = 7 | | T = 9 | | T = 11 | |
|---|---|---|---|---|---|---|
| | Expected | Observed | Expected | Observed | Expected | Observed |
| | effect | effect | effect | effect | effect | effect |
| Preparation 3 | 32 | 60 | 45 | 63 | 55 | 65 |

Thus, as shown in Table 4, the observed effect is much greater than the expected effect calculated by Colby for the first few days of experimentation. Thus, a synergistic effect of the combination of laccase inhibitor and insecticide is observed for the combinations of the invention on the volume of the fungus garden.

The garden fungus is important to the colony, as it is its gongylidia (enlarged hyphae) that provide food for all the colony's actors (larvae, workers, soldiers and the queen). The fungus is particularly important for the larvae since they are placed there and covered with hyphae by the workers. In addition, the decline of the larvae leads to the decline of the colony as the workers become apathetic (Lopes et al., 2005).

The combined preparations of the invention therefore allow the entire colony to be targeted by affecting the garden fungus, the source of food for the entire colony and presumably of primary importance to the larvae. The suddenness of this effect on the fungus, associated with the mortality on the ants, allows considering the inhibition of all nest relocation, as well as the prevention of the survival of a colony after the end of the treatment, with the larvae being probably affected by the destruction of the fungus.

Ant Mortality.

Also surprisingly, an acceleration of ant mortality is also observed for colonies treated with the combined preparations of the invention comprising a laccase inhibitor and an insecticide, even though compositions comprising only laccase inhibitors as active agent do not induce significant mortality in experiments. In addition, these combinations are as effective in killing ants as preparations containing only the insecticide as active agent, despite the lower insecticide concentrations of the preparations of the invention. (Table 5).

TABLE 5

| | | Mortality similar to the |
|---|---|---|
| | | commercial dose of |
| | Accelerated mortality* | insecticide used alone |
| Preparation 2 | yes | yes |
| Preparation 3 | yes | yes |
| Preparation 8 | yes | yes |
| Preparation 9 | yes | yes |
| Preparation 10 | yes | yes |
| Preparation 11 | yes | yes |
| Preparation 15 | yes | yes |
| Preparation 16 | yes | yes |
| Preparation 17 | yes | yes |
| Preparation 18 | yes | yes |

*Compared to a colony treated with insecticide alone at an equivalent dose

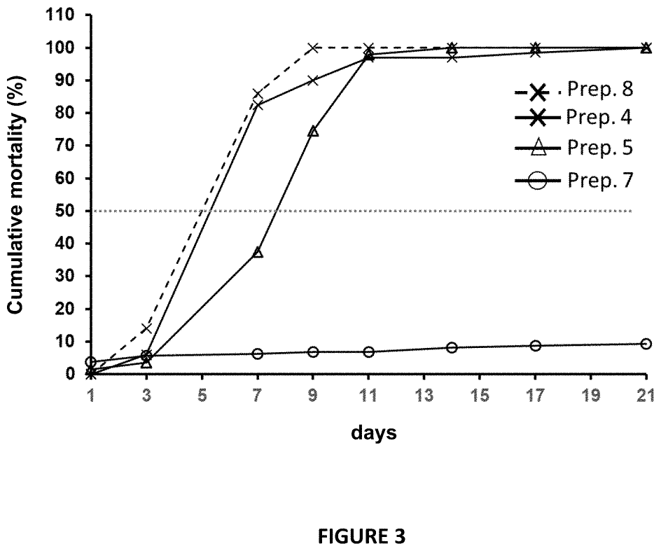

This is particularly illustrated in FIG. 3. No significant mortality was observed for ants in colonies treated with ascorbic acid alone (Preparation 7). The 50% mortality in the colonies is reached from the 5^{th} day for the colonies treated with the preparation comprising 1% ascorbic acid and 0.1% sulfluramide, or the preparation comprising 0.3% sulfluramide as the only active agent. It takes 8 days to observe 50% mortality in colonies treated with 0.1% sulfluramide alone.

### CONCLUSION

These experiments carried out under standardized conditions allowed an optimized analysis of the results obtained by minimizing the experimental variations.

They show that the combination of a laccase inhibitor with an insecticide results in potentiating effects of the toxicity of the insecticide and the laccase inhibitor in its effect on the garden.

These effects allow for an abrupt decline of the colony and target all the actors in the colony simultaneously within a few days, unlike the laccase inhibitor or the insecticide used alone.

### BIBLIOGRAPHIC REFERENCES

Amante E. (1967). Saúva tira boi da pastagem. Coopercotia 23: 38-40.
Boulogne, I., Petit, P., Ozier-Lafontaine, H. et al. Insecticidal and antifungal chemicals produced by plants: a review. Environ Chem Lett 10, 325-347 (2012)
Bourbonnais R., Paice M. G., 1990. Oxidation of non-phenolic substrates. An expanded role for laccase in lignin biodegradation. FEBS, 267, 99-102)
Cantarelli E. D., Costa E. C., Pezzutii R. & Oliveira L. S. (2008). Quantificação de perdas no desenvolvimento de Pinus taedaapós o ataque de formigas cortadeiras. Ciência Florestal. 18:39-45.
Colby, S. (1967). Calculating Synergistic and Antagonistic Responses of Herbicide Combinations. Weeds, 15(1), 20-22.
Fisher P J, Stradling D J and Pegler O N. Leaf cutting ants, their fungus gardens and the formation of basidiomata of Leucoagaricus gongylophorus. Mycologist (1994) 8, 3, 128-131
Forti L. C. & Boaretto M. A. C. (1997). Formigas cortadeiras: Biologia, ecologia, danos e controle. Botucatu: Departamento de Defesa Fitossanitária, Universidade Estadual Paulista. 61
Fowler H. G., Forti L. C. & Ronagnano L. F. T. (1990). Methods for the evaluation of leaf cutting and harvest. In: R. K. Vandermeer, K. Jaffé And A. Cedeno (Eds). Applied myrmecology—A world perspective. Westview Press, Boulder, San Francisco and Oxford
Isenring R. & Neumeister L. (2010). Recommendations regarding derogations to use alpha Cypermethrin, Deltamethrin, Fenitrothion, Fipronil and Sulfluramid in FSC Certified Forests in Brazilll, FSC Editor. 99p
Lopes, J. F. S., Hughes, W. O. H., Camargo, R. S. et al. (2005) Larval isolation and brood care in Acromyrmex leaf-cutting ants. Insect. Soc. 52, 333-338.
Jian-Ming Lü, Peter H. Lin, Qizhi Yao, Changyi Chen (2010) Chemical and molecular mechanisms of antioxidants: experimental approaches and model systems J. Cel/. Mol. Med. Vol 14. 840-860
Precetti A. A. C. M., Oliveira J. E. & Palini J. R. (1988). Perdas de produção em cana-de-açúcar causadas pela saúva mata-pasto, Atta bisphaerica. Parte I. Boletim Técnico Copersucar, Piracicaba. 42: 19-26.
Qinlan R J and Cherrett J M, Aspects of the symbiosis of the leaf-cutting ant Acromyrmex octospinosus (Reich) and its food fungus. Ecological Entomology (1978) 3, 221-230
Reis Filho W., Santos F., Strapasson P. & Nickele M. A. (2011). Danos causados por diferentes niveis de desfolha artificial para simulação do ataque de formigas cortadeiras em Pinus taedae Eucalyptus grandis. Pesquisa Florestal Brasileira. 31: 37-42
Richard F J, Mora P, Errard C and Rouland C, Digestive capacities of leaf-cutting ants and the contribution of their fungal cultivar to the degradation of plant material. J Camp Physiol B (2005) 175: 297-303
Zanetti, R.; Zanuncio, J. C.; Santos, J. C.; Da Silva, W. L. P.; Ribeiro, G. T.; Lemes, P. G. An Overview of Integrated Management of Leaf-Cutting Ants (Hymenoptera: Formicidae) in Brazilian Forest Plantations. Forests 2014, 5, 439-454.

1. A combined formicide preparation comprising, formulated separately or in a single composition, at least one insecticide belonging to the phenylpyrazole family, the neonicotinoid family or the sulfonamide family, and at least one laccase inhibitor selected from: an antioxidant molecule, a chelator, a detergent, a non-oxidizing organic acid and a cationic metal, said laccase inhibitor being present in the preparation at a content greater than or equal to 0.5% by weight of the preparation, and a mass ratio between the at least one laccase inhibitor and the at least one insecticide in the preparation being greater than or equal to 2.

2. The combined formicide preparation according to claim 1, wherein the at least one insecticide is selected from: fipronil, sulfluramide and mixtures thereof.

3. The combined formicide preparation according to claim 1, wherein the mass ratio between the at least one laccase inhibitor and the at least one insecticide is greater than or equal to 5.

4. The combined formicide preparation according to claim 1, wherein a concentration of the at least one insecticide in the preparation is less than or equal to 0.3% by weight of the preparation.

5. The combined formicide preparation according to claim 1, wherein the at least one laccase inhibitor is selected from: glutathione, L-cysteine, sodium thiosulfate, ascorbic acid, eugenol and mixtures thereof.

6. The combined formicide preparation according to claim 1, wherein a content of the at least one laccase inhibitor in the preparation is greater than or equal to 1% by weight of the preparation.

7. The combined formicide preparation according to claim 1, wherein the at least one laccase inhibitor is ascorbic acid or L-cysteine, and the at least one insecticide is fipronil, sulfluramide or a mixture thereof.

8. The combined formicide preparation according to claim 1, wherein the at least one laccase inhibitor is ascorbic acid, and the at least one insecticide is sulfluramide.

9. The combined formicide preparation according to claim 1, wherein the at least one laccase inhibitor and the at least one insecticide are provided in a single composition.

10. A method of controlling fungus-growing ants, comprising dispensing indirectly on or around a nest or near crop columns combined formicide preparation,
the combined formicide preparation comprising, formulated separately or in a single composition:
at least one insecticide belonging to the phenylpyrazole family, the neonicotinoid family or the sulfonamide family, and
at least one laccase inhibitor selected from: an antioxidant molecule, a chelator, a detergent, a non-oxidizing organic acid and a cationic metal,
said laccase inhibitor being present in the preparation at a content greater than or equal to 0.5% by weight of the preparation,
a mass ratio between the at least one laccase inhibitor and the at least one insecticide in the preparation being greater than or equal to 2.

11. The combined formicide preparation according to claim 1, wherein the mass ratio between the at least one laccase inhibitor and the at least one insecticide is greater than or equal to 10.

12. The combined formicide preparation according to claim 1, wherein a concentration of the at least one insecticide in the preparation is less than or equal to 0.1% by weight of the preparation.

13. The combined formicide preparation according to claim 1, wherein a content of the at least one laccase inhibitor in the preparation is between 1% and 10% by weight of the preparation.
